(19) United States
(12) Patent Application Publication
(10) Pub. No.: US 2014/0253605 A1
(43) Pub. Date: Sep. 11, 2014

(54) CONTROLLING BRIGHTNESS OF A DISPLAYED IMAGE

(71) Applicants: John N. Border, Eaton, NH (US); John D. Haddick, Mill Valley, CA (US); Ralph F. Osterhout, San Francisco, CA (US)

(72) Inventors: John N. Border, Eaton, NH (US); John D. Haddick, Mill Valley, CA (US); Ralph F. Osterhout, San Francisco, CA (US)

(21) Appl. No.: 14/197,129

(22) Filed: Mar. 4, 2014

Related U.S. Application Data
(60) Provisional application No. 61/772,678, filed on Mar. 5, 2013.

(51) Int. Cl. G02B 27/01

(52) U.S. Cl. CPC G02B 27/0172
USPC 345/690

(57) ABSTRACT

The disclosure relates to adjusting a brightness of an image displayed on a see-through display in response to a measured brightness of a see-through view. In one example, the brightness of the see-through view is measured via a sensor located behind a see-through display so that the measured brightness corresponds to the brightness perceived by the user's eyes. Changes in brightness of the displayed image are determined in correspondence to changes in the measured brightness of the see-through view.

### CROSS-REFERENCE TO RELATED APPLICATIONS

This application claims priority to U.S. Provisional Patent Application No. 61/772,678, entitled BRIGHTNESS CONTROL IN A HEAD MOUNTED DISPLAY and filed Mar. 5, 2013, the entirety of which is hereby incorporated by reference.

### BACKGROUND

See-through head worn displays provide a combined image to a user comprising a displayed image and a see-through view of the scene in front of the user. As such, the light from the see-through view can make it difficult to view the displayed image. For example, when the scene in front of the user is brighter, the contrast between the background scene and displayed image may decrease. This may make it more difficult to view displayed images.

### SUMMARY

Embodiments are disclosed herein that relate to adjusting a brightness of an image displayed on a see-through display in response to a measured brightness of a see-through view. For example, in some embodiments, the brightness of the see-through view is measured via a sensor located behind a see-through display so that the measured brightness corresponds to the brightness perceived by the user's eyes. Changes in brightness of the displayed image are determined in correspondence to changes in the measured brightness of the see-through view.

### DESCRIPTION OF FIGURES

FIG. 1 is an illustration of an example see-through head mounted display device;

FIG. 2 is an illustration of an example of a combined image as seen by a user with the see-through display device;

FIGS. 3A and 3B are cross sectional illustrations of example lens assemblies in see-through head mounted displays;

FIG. 4 is a cross sectional illustration of an example lens assembly on a user's head with a brightness sensor behind the shield lens;

FIG. 5 is a cross sectional illustration of an example lens assembly on a user's head with a brightness sensor behind the shield lens and mounted to the sides on the arms or frame;

FIG. 6 is a chart showing a non-linear relationship between the brightness (L*) perceived by a human eye and the measured luminance of a scene or displayed image;

FIG. 7 is a chart showing a perceived brightness (L*) of a see-through view and a displayed image with d=2;

FIG. 8 is a chart of a ratio between display luminance and measured see-through luminance to provide a 2× perceived brighter displayed image compared to the see-through view (d=2) over w wide range of measured see-through view luminance;

FIG. 9 is a flow chart depicting an example of a method of automatically controlling display brightness; and

FIG. 10 is a flow chart depicting another example of a method of automatically controlling display brightness.

FIG. 11 is a block diagram of an example computing device.

### DETAILED DESCRIPTION

In a see-through head mounted display, a displayed image can be viewed by a user at the same time that a see-through view of the scene from the surrounding environment can be viewed. However, as mentioned above, environmental light may make it difficult to view the displayed image, depending upon a relative brightness of the displayed image and the see-through view. Thus, to help improve contrast between an image displayed on a see-through display and a background environment viewable through the see-through display, a brightness of the displayed image may be increased as the brightness of the background scene increases, and/or electrochromic or photochromic shield lenses may be used for automatically darkening or lightening in response to changes in brightness in the environment.

However, the difference in brightness between the displayed image and the see-through view as seen by the user's eye determines the discernibility of the displayed image. Thus, this disclosure relates to controlling a brightness of an image displayed on a see-through head mounted display via measuring a brightness of a see-through view via light sensor located on a same side of a see-through display as a user's eye, and adjusting a brightness of a displayed image based upon the measured brightness.

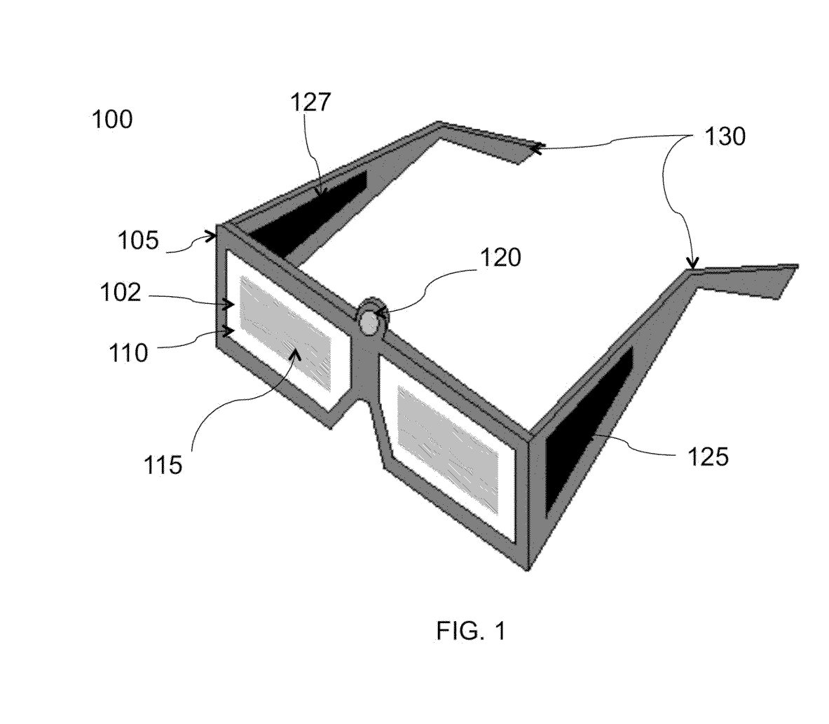

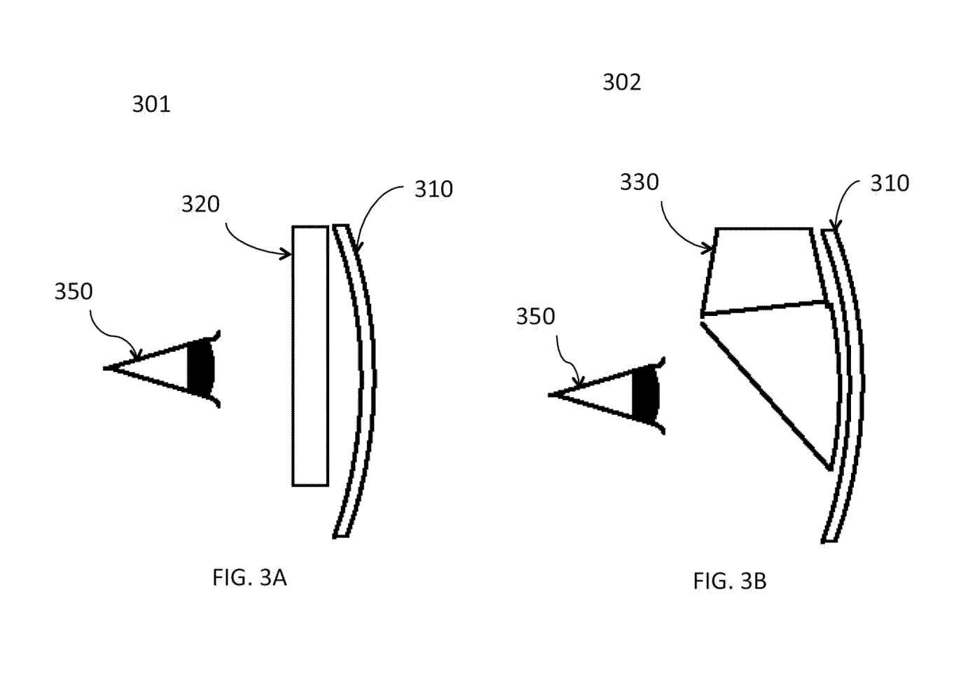

FIG. 1 shows an illustration of an example see-through head mounted display device 100. The device includes a frame 105 with one or more lenses 110 that cover display areas 115 and clear areas 102. FIGS. 3A and 3B show a cross sectional illustration of two versions of lens assemblies 301 and 302 which represent the one or more lenses 110, wherein the one or more lenses 110 includes a shield lens 310, which can be tinted with a constant darkness of tint or can be electrochromic or photochromic with variable darkness of tint or variable optical density. The lens assemblies 301 and 302 also include display optics 320 and 330 respectively, which include image sources and associated optics (not shown) to present image light from the image source to the display areas 115, wherein the image sources and associated optics can be located at the top as shown in FIG. 3B, the bottom (not shown), the side 320 of the display areas 115 as shown in FIG. 3A, or at any other suitable location. For the see-through head mounted display device 100, at least portions of the display optics 320, 330 and the associated shield lenses 310 are transparent so the user's eye 350 is provided with a displayed image overlaid onto a see-through view of the surrounding environment. The frame 105 is supported on the viewer's head with arms 130. The arms 130 and/or other portions of the see-through head mounted display device 100 also may contain electronics 125 including a processor and/or other suitable logic device(s) to drive the displays, memory to store instructions executable by the logic device(s) to operate the various functions of the see-through head mounted display devices, and peripheral electronics 127 including batteries and wireless connection(s) to other information sources such as can be obtained on the internet or from localized servers through Wifi, Bluetooth, cellular or other wireless technologies.

Further, a camera 120, or a plurality of cameras, can be included to capture images of the surrounding environment. Any suitable camera or cameras may be used. For example, the see-through head mounted display device 100 may include an outward-facing color image camera, grayscale camera, one or more depth cameras (e.g. time of flight and/or structured light camera(s), a stereo camera pair, etc. Further, the see-through head mounted display device 100 also may include one or more inward-facing (e.g. user-facing), cameras, such as cameras that are part of an eye tracking system. Eye tracking cameras may be used in conjunction with one or more light sources to image light from the one or more light sources as reflected by a user's eye. The locations of the reflections relative to a user's pupil may be used to determine a gaze direction. The gaze direction may then be used to detect a position at which the user gazes on a user interface displayed on the see-through display. Additionally, the see-through head mounted display device 100 may include any other suitable electronics, including but not limited to various sensors, such as motion sensor(s), location sensors (e.g. global positioning sensors), microphones, touch sensor(s), etc. It will be understood that the locations of the various components in the see-through head mounted display device 100 are shown as an example, and other locations are possible.

The see-through head mounted display device 100 can further include controllable darkening layers for the display areas 115, wherein the controllable darkening layers can change opacity behind the respective portions of the display areas 115 to enable changes in operating mode between transparent, semi-transparent and opaque in the areas where images are displayed. The controllable darkening layers can be included in the shield lenses 310 or in the display optics 320 and 330. The controllable darkening layers can be segmented so that images can be displayed over different portions of the display areas 115.

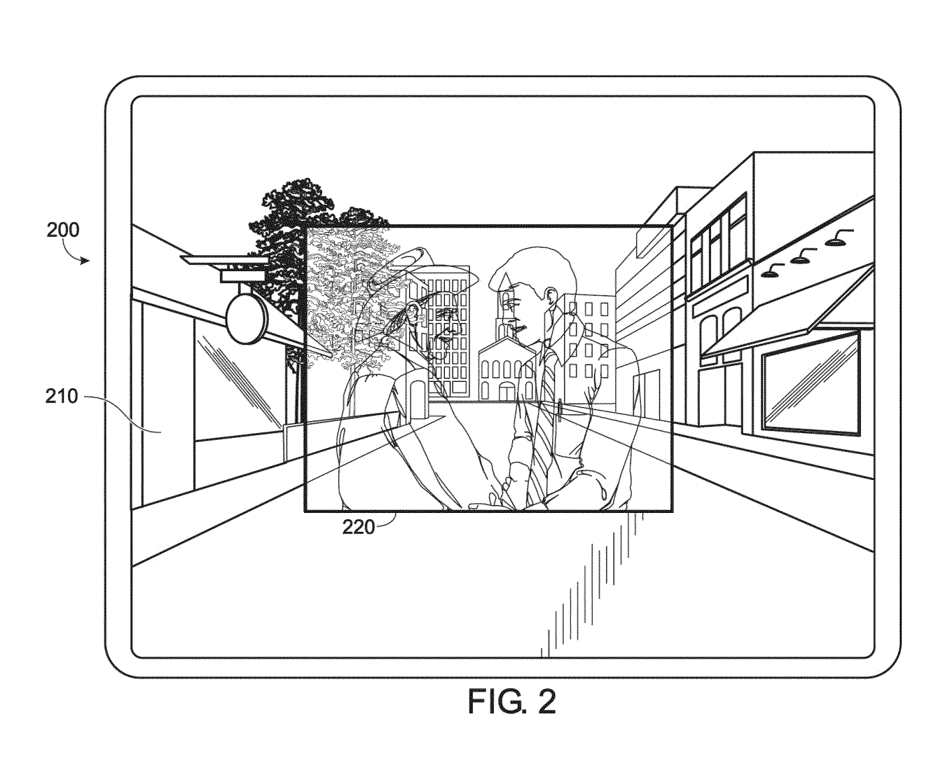

FIG. 2 shows an example of a combined image 200 as seen by a user using a see-through head mounted display device 100 wherein the see-through head mounted display device 100 is operating in a transparent mode. As can be seen in FIG. 2, the combined image 200 seen by the user comprises a displayed image 220 provided by an image source overlaid onto a see-through view 210 of the scene in front of the user. It will be understood that the image of FIG. 2 is presented for the purpose of example, and that any suitable image or images may be displayed. For example, virtual images may be displayed such that the images appear to exist in the background scene (e.g. by displaying stereoscopic images). Further, virtual images may be displayed such that the virtual images are fixed in position relative to an object in the background scene (e.g. via recognition of objects imaged by an outward-facing camera), fixed in position relative to the display screen, or fixed in position relative to any other suitable coordinate frame. Further, various types of images may be displayed, including but not limited to still images, video images, computer graphics images, user interface images, etc.

See-through head mounted display devices, such as see-through head mounted display device 100, may have a variety of configurations. For example, see-through head-mounted display devices can provide image information to one eye of the user or both eyes of the user. See-through head mounted display devices that present image information to both eyes of the user can have one or two image sources. Monoscopic viewing in which the same image information is presented to both eyes is done with see-through head mounted display devices that have one or two image sources, whereas stereoscopic viewing utilizes a head-mounted display device that has two image sources with different images being presented to the user's eyes, wherein the different images have different perspectives of the same scene.

A variety of image sources may be used to provide images for display, including, for example, organic light-emitting diode (OLED) displays, quantum dot based light emitting diodes (QLED) displays, liquid crystal displays (LCDs), or liquid crystal on silicon (LCOS) displays. In addition, the image sources can be microprojectors or microdisplays with associated optics, or self luminant displays to present the image light to the display areas 115 so that the user can view the displayed images with his/her eyes.

The optics associated with the image sources relay the image light from the image sources to the display areas 115. The optics can comprise refractive lenses, reflective lenses, mirrors, diffractive lenses, holographic lenses or waveguides. For a see-through head mounted display device, the user may be provided with at least a partial view of the scene in front of the see-through head-mounted display device within the user's field of view.

The embodiments disclosed herein provide for the automatic control of the brightness of the displayed image 220 presented to the user's eye. As described above, the brightness of the scene in front of the user changes depending on the lighting. For example, when the environment is lit by full sun, the background scene viewed through a see-through display device is much brighter than if the environment is lit by moonlight. In addition, the darkness or optical density of the shield lens 310 may change.

Thus, to maintain a more consistent perceived brightness of a displayed image 220 relative to the see-through view 210, a control system for the see-through head mounted display device 100 may take into account the actual brightness of the see-through view 210 presented to the user's eye. For this, a see-through head mounted display device may include a brightness sensor located behind the shield lenses 310 for measuring the brightness of the see-through view 210 in a way that corresponds to the brightness seen by the user's eye. Any suitable light sensor may be used. One non-limiting example is the APDS 9300 light sensor available from Avago Technologies of Singapore, available via Avago Technologies Americas Sales Office of San Jose, Calif.

Additionally, in some examples, a see-through head mounted display device may take into account the way the human eye perceives different levels of brightness and changes in brightness in determining the brightness of the displayed image 220 to be presented. For such examples, adjustments in a brightness of a displayed image 220 take into account the non-linear sensitivity of the human eye so that the displayed image 220 can be presented with a consistent difference in perceived brightness relative to the measured brightness of the see-through view 210 regardless of changes in the brightness of the environment and changes in the darkness of the shield lens 310. Such adjustments may be made via a shield lens 310 comprising a tinted lens with constant optical density, an electrochromic or photochromic lens with an optical density that changes in response to the brightness of the environment, and/or in any other suitable manner

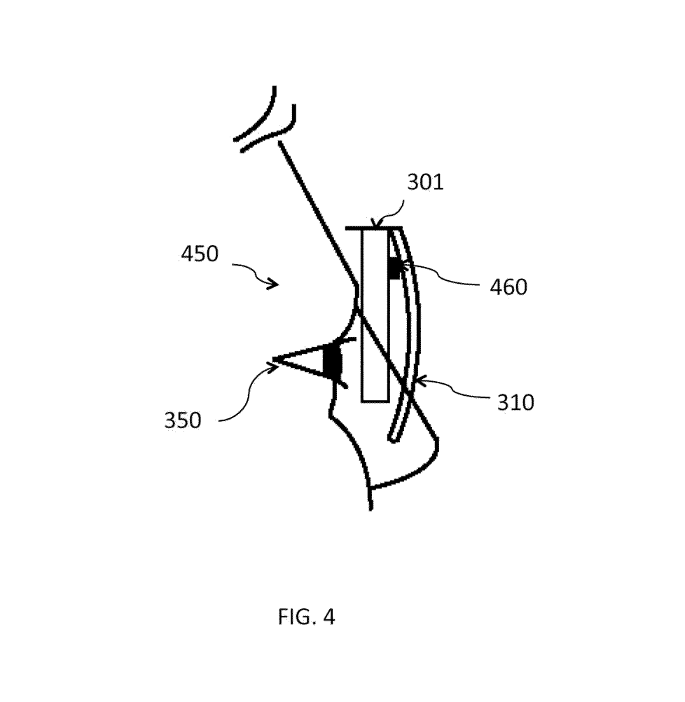

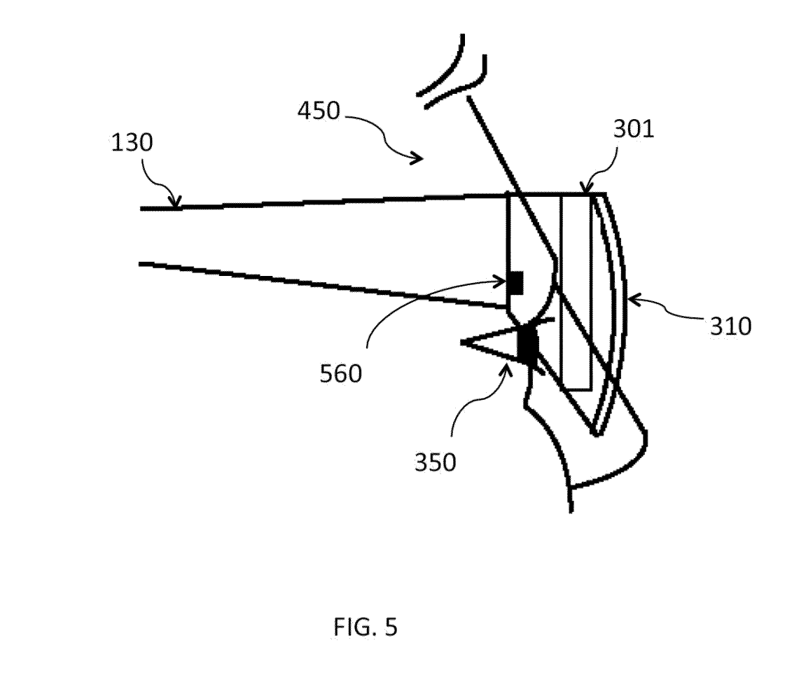

FIG. 4 shows an example head mounted display device that includes a simple brightness sensor 460 such as a photodiode provided behind the shield lens 310 and near the top to enable the average brightness of light from the see-through view 210 to be measured. FIG. 5 shows another example where a simple brightness sensor 560 is located behind the shield lens 310 and near the side of the user's eye 350 in the arms 130 or at the edge of the frame 105. Other examples, such as behind the lens assembly 301 and above the user's eye 350, are possible, so long as the simple brightness sensor 460 or 560 is located behind the shield lens. In addition, the simple brightness sensor 460 or 560 may be selected and positioned so that it has a field of view and points in the same direction that the displayed image 220 occupies in the user's see-through view 210. A lens or other optical structure can be added to the brightness sensor 460 or 560 to match the sensor field of view to the user's see-through field of view. By positioning the simple brightness sensor 460 or 560 behind the shield lens 310, changes in the darkness or optical density of the shield lens 310 and the associated changes in the brightness of the see-through view 210 can be determined and the brightness of the displayed image 220 can be changed to provide a more viewable displayed image 220 and a more viewable see-through view 210. Thereby, a control system that automatically changes the brightness of the displayed image 220 in correspondence to changes in the brightness of the see-through view may be provided.

Changes in the brightness of the see-through view can be caused by changes in the makeup of the scene, changes in lighting of the scene, changes in the darkness or optical density of the shield lens, or combinations thereof. As an example, if the measured brightness of the see-through view 210 changes by 2X, the average brightness of the displayed image 220 can be changed by 2X, or by any other suitable amount. The average brightness of the displayed image 220 can be changed by different methods including: changing the average digital brightness of the displayed image; changing the illumination of the image source in the display optics (such as by increasing the power to an LED light source by changing the voltage current or duty cycle of the current); changing the illumination efficiency in the display optics with a variable darkness layer (such as an electrochromic layer) or a variable reflectance layer (such as a variable reflectance mirror). The average digital brightness of the displayed image can be determined by averaging the pixel code values within the image. Alternately, the average brightness of the displayed image can be determined by determining the luma of the displayed image (see “Brightness Calculation in Digital Image Processing”, Sergey Bezryadin et. al., Technologies for Digital Fulfillment 2007, Las Vegas, Nev.). Example digital methods for brightness editing are described in U.S. Pat. No. 7,489,420. To make the displayed image 220 more viewable in the combined image 200, the displayed image 220 may be provided so it is perceived to be brighter than the see-through view 210, but embodiments also can be used to provide a displayed image 220, which has a lower perceived brightness than the see-through view 210.

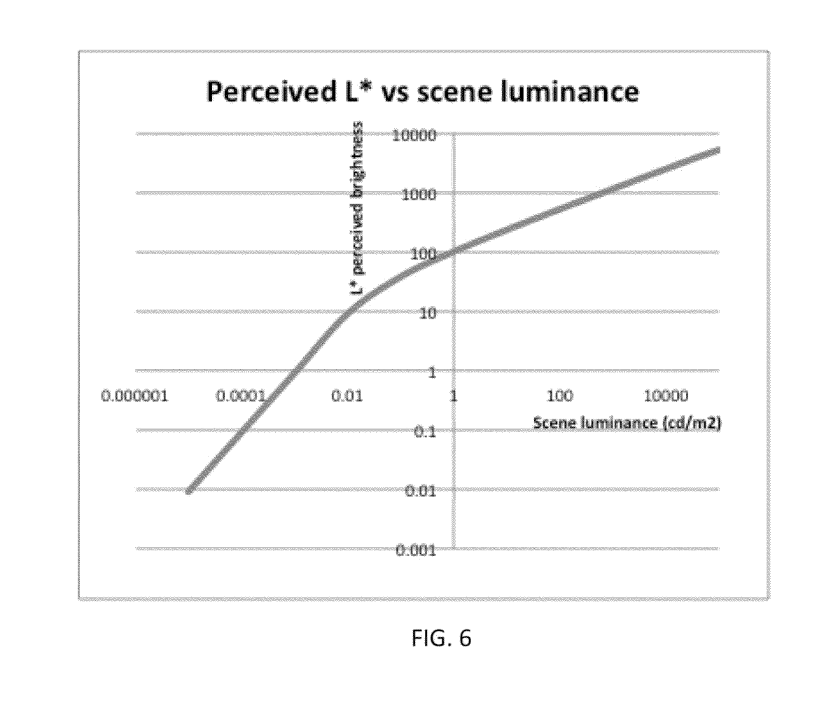

The human eye has a non-linear sensitivity to scene brightness. At low levels of brightness, the human eye is very sensitive to changes in brightness while at high levels of brightness, the human eye is relatively insensitive (i.e., the human eye is nonlinear). In contrast, electronic sensors such as the simple brightness sensor 460 or 560 are linearly sensitive to changes in brightness. For purposes of discussion, the perceived brightness or perceived lightness is commonly known as L*. FIG. 6 shows the nonlinear relationship between perceived brightness (L*) by the human eye vs measured brightness (luminance) as taken from the article “Gamma” and its Disguises: The Nonlinear Mappings of Intensity in Perception, CRTs, Film and Video” by Charles A. Poynton, SMPTE Journal, December 1993, pp 1099-1108. While various mathematical relationships between perceived brightness (L*) and luminance of scenes or displayed images have been described in the literature, the relationship between L* and luminance Y given by CIE (Commision Internationale de l'Eclairage, the international society for color measurement) and presented by Poynton is shown below as an example.

L*=116(Y/Yₙ)^{1/3}−16 for Y/Yₙ>0.008856

and

L*=903.3(Y/Yₙ) for Y/Yₙ<0.008856 EQN 1

where Y is the luminance (cd/m2) of a scene or a displayed image and Yₙ is a normalizing luminance of a white reference surface, which is typically 1 cd/m2 but can be another value.

In a further embodiment of the invention, an automated brightness control system is provided in which the average luminance of the displayed image 220 as provided to the user by the control system is selected corresponding to the measured luminance of the see-through view provided by the simple brightness sensor 460. This control system takes into account the nonlinear sensitivity of the human eye known as the gamma curve. In the control system, a predetermined brightness difference d is the desired ratio between the perceived average see-through brightness L*ₐₛₜ and the average perceived brightness of the displayed image L*_{adi}, which is shown below, is EQN 2. The brightness difference d can be chosen by the user to match the viewing preferences of the user or it can be automatically selected based on a detected use scenario, such as whether the user is moving or stationary and how fast the user is moving or what the external scene is as determined by the camera 120.

d=L*_{adi}/L*ₐₛₜ EQN 2

EQN 2 can be combined with EQN 1 to provide an equation for determining the average luminance of the displayed image Y_{adi}, which is given as EQN 3 below, where the term Yₐₛₜ refers to the measured luminance of the see-through view.

$$\begin{matrix}\begin{matrix}{Y}_{adi} = {{Y}_{n} ( ( {dL}_{ast}^{*} + 16 ) / 116 )}^{3} \\ = {Y}_{n} ( ( d ( 116 {Y}_{ast}^{1 / 3} - 16 ) + 16 ) / 116 ) 3 for {Y}_{ast} / {Y}_{n} > 0.008856\end{matrix} & EQN 3 \\ and \\ \begin{matrix}{Y}_{adi} = {Y}_{n} ( {dL}_{ast}^{*} / 903.3 ) \\ = {Y}_{n} ( d ( 903.3 {Y}_{ast} ) / 903.3 ) for {Y}_{ast} / {Y}_{n} < 0.008856\end{matrix} & \end{matrix}$$

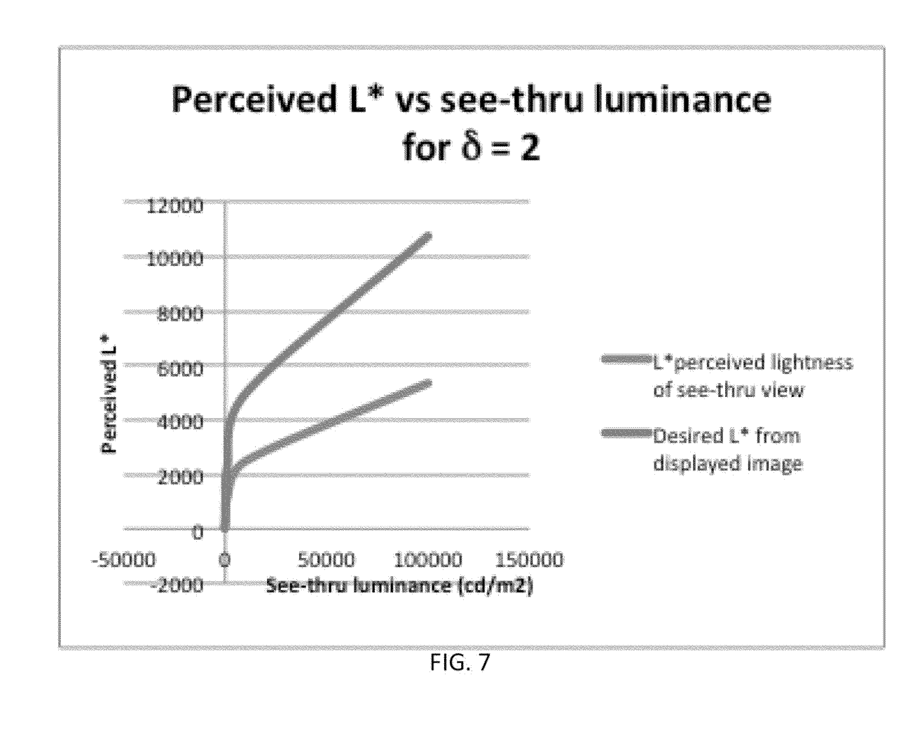

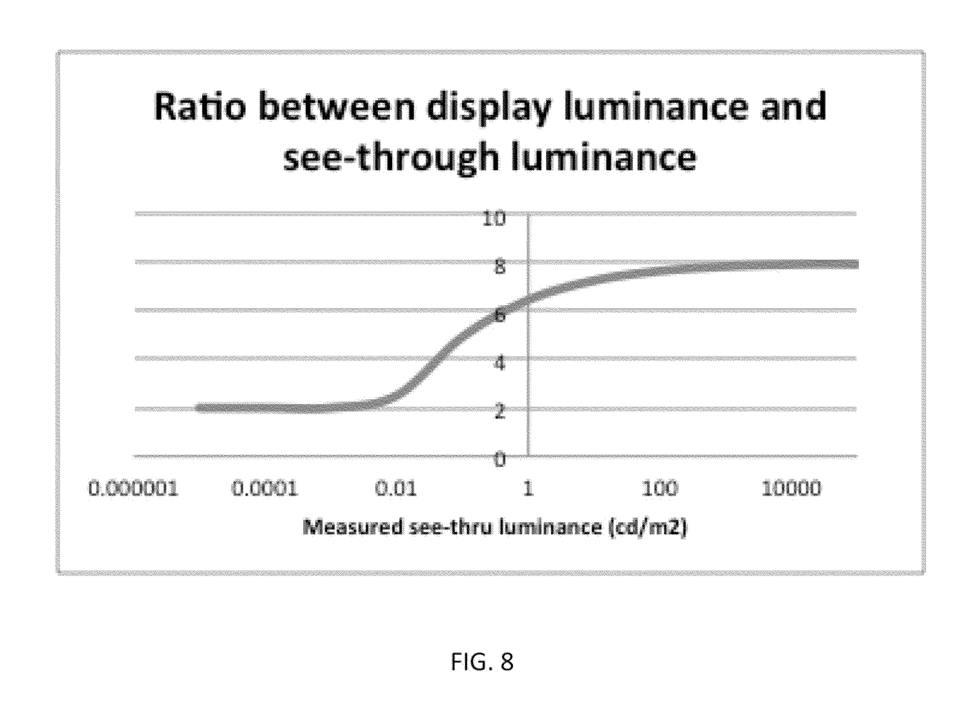

As a result, if a displayed image on a head mounted see-through head mounted display device 100 is to be shown as twice as bright as the see-through view, in a dim environment the displayed image 220 may only need to be slightly brighter than the see-through view 210, while in a bright environment the displayed image 220 may need to be substantially brighter than the see-through view 210. FIG. 7 shows the perceived brightness (L*) of a see-through view versus the perceived brightness of a displayed image for d=2. Over the wide range of perceived brightness shown, the ratio is always 2× due to the control system of the invention. Conversely, FIG. 8 shows the ratio of display luminance Y_{adi} to the measured see-through luminance Yₐₛₜ to provide a constant 2X ratio of perceived brightness between the displayed image 220 and the see-through view 210 (d=2), as can be seen, the ratio varies from 2 in dim conditions (low luminance) to 8 for bright conditions (high luminance).

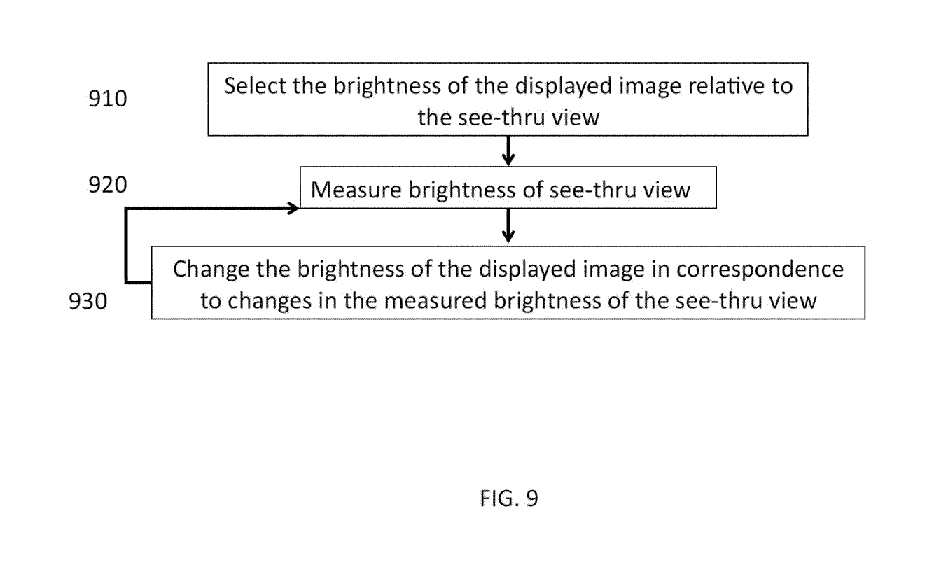

FIG. 9 is a flow chart of an example method for operating a see-through head mounted display device. In step 910, the user selects the brightness of the displayed image 220 relative to the see-through view 210 for good viewing. In step 920, the brightness of the see-through view 210 is measured using a brightness sensor 460 or 560 positioned inside the shield lens 310. In step 930, the brightness of the displayed image 220 is changed in correspondence to measured changes in the brightness of the see-through view 210. Steps 920 and 930 are repeated automatically over the time that the user is using the see-through head mounted display device 100, or that the see-through head mounted display is otherwise in operation. The brightness of the displayed image 220 can be changed by different methods including: changing the average digital brightness of the displayed image; changing the illumination of the image source in the display optics; changing the illumination efficiency in the display optics with a variable darkness layer (such as an electrochromic layer) or a variable reflectance layer (such as a variable reflectance mirror).

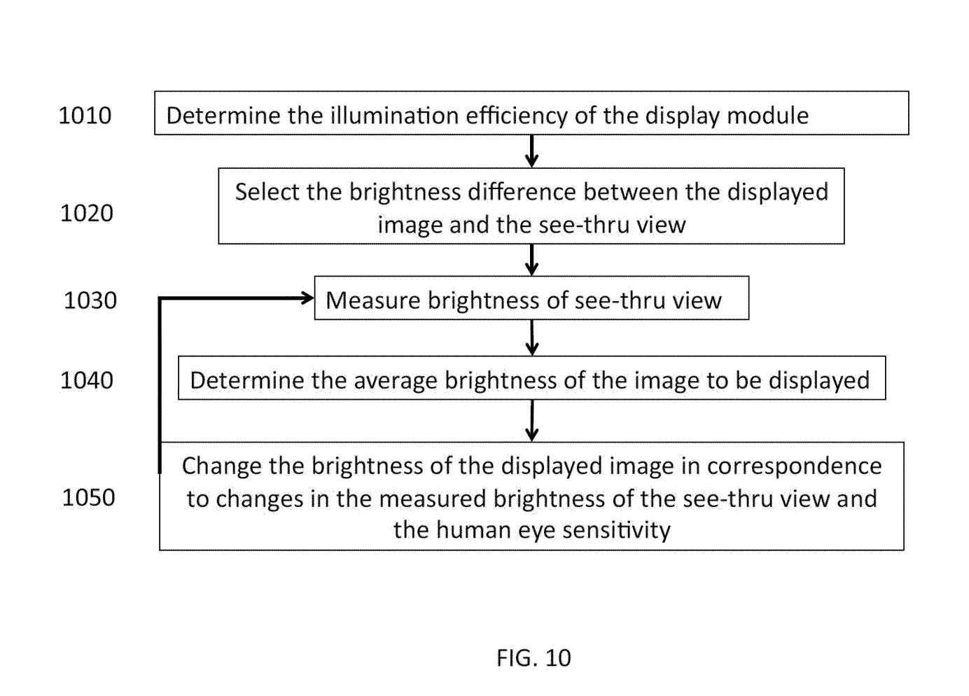

FIG. 10 is a flow chart of another example of a method for operating a see-through head-mounted display device. In step 1010, the illumination efficiency of the display optics 320 or 330 is determined, wherein the illumination efficiency relates the average digital brightness (luma) of the displayed image 220 to the average brightness of the displayed image, Y_{adi}, presented to the user's eye 350. The illumination efficiency is a function of the illumination applied to the image source in the display optics 320 or 330 and losses in the display optics 320 or 330. In step 1020, the user selects a brightness difference (d) between the displayed image 220 and the see-through view 210 to provide good viewability of the displayed image 220 or the see-through view 210. In step 1030, the brightness of the see-through view Yₐₛₜ is measured using a brightness sensor 460 or 560 positioned inside the shield lens 310. In step 1040, the average brightness of the displayed image Y_{adi} is determined from the average digital brightness luma) of the displayed image and the illumination efficiency of the display optics 330 or 340. In step 1050, the brightness of the displayed image Y_{adi} is changed in correspondence to measured changes in the brightness of the see-through view Yₐₛₜ and the sensitivity of the human eye as described for example by EQN 3. Steps 1030, 1040 and 1050 are repeated automatically for the time period that the user is using the see-through head mounted display device 100 or that the see-through head mounted display device 100 otherwise in operation.

In a further example, the brightness sensor 460 or 560 can be a low resolution image sensor which has multiple pixels. In this way the brightness of different portions of the field of view can be determined Changes to the brightness of the displayed image can be made based on the average brightness of the scene, the maximum brightness of the scene, the brightness of the center of the scene and/or the brightness of the portion of the scene where an image is displayed such as at the edge. It will be understood that, in other embodiments, any suitable sensor may be used as a brightness sensor, including but not limited to an image sensor.

In yet another example, the measured brightness of the scene can be used to change the way the displayed image is presented. For example, if the scene is determined to be very dim, the displayed image can be changed to a grey scale image or, a red or green image to enable to user's eye to better adapt to the dim conditions. Alternately, if the scene is determined to be too bright, the contrast in the displayed image can be increased. For this embodiment, a predetermined threshold would be selected wherein the change in the way the displayed image is presented occurs when the threshold is exceeded. Wherein the threshold can be selected to be exceeded by either being above the threshold or below the threshold.

The advantage of this control system is that more consistent viewability of the displayed image overlaid onto the see-through view is provided over a wide range of environmental conditions from dim to bright and a wide range of shield lens darkness or optical density. The user can choose the relative brightness of the displayed image versus the see-through view and the system can maintain a more constant perceived difference.

In some embodiments, the methods and processes described herein may be tied to a computing system of one or more computing devices. In particular, such methods and processes may be implemented as a computer-application program or service, an application-programming interface (API), a library, and/or other computer-program product.

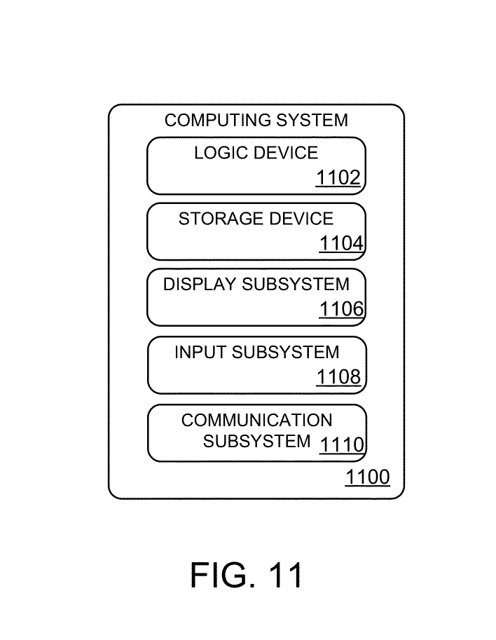

FIG. 11 schematically shows a non-limiting embodiment of a computing system 1100 that can enact one or more of the methods and processes described above. Computing system 1100 is shown in simplified form. Computing system 1100 may take the form of a head mounted display device, other see-through display device, and/or one or more personal computers, server computers, tablet computers, home-entertainment computers, network computing devices, gaming devices, mobile computing devices, human interface devices, mobile communication devices (e.g., smart phone), and/or other computing devices.

Computing system 1100 includes a logic machine 1102 and a storage machine 1104. Computing system 1100 may optionally include a display subsystem 1106, input subsystem 1108, communication subsystem 1110, and/or other components not shown in FIG. 11.

Logic machine 1102 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1104 includes one or more physical devices configured to hold instructions executable by the logic machine to implement the methods and processes described herein. When such methods and processes are implemented, the state of storage machine 1104 may be transformed—e.g., to hold different data.

Storage machine 1104 may include removable and/or built-in devices. Storage machine 1104 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1104 may include volatile, nonvolatile, dynamic, static, read/write, read-only, random-access, sequential-access, location-addressable, file-addressable, and/or content-addressable devices. Storage machine 804 and logic machine 802 may in some embodiments be incorporated in controller on a human interface device.

It will be appreciated that storage machine 1104 includes one or more physical devices. However, aspects of the instructions described herein alternatively may be propagated by a communication medium (e.g., an electromagnetic signal, an optical signal, etc.), as opposed to being stored via a storage medium.

Aspects of logic machine 1102 and storage machine 1104 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 1100 implemented to perform a particular function. In some cases, a program may be instantiated via logic machine 1102 executing instructions held by storage machine 1104. It will be understood that different programs may be instantiated from the same application, service, code block, object, library, routine, API, function, etc. Likewise, the same program may be instantiated by different applications, services, code blocks, objects, routines, APIs, functions, etc. The term program may encompass individual or groups of executable files, data files, libraries, drivers, scripts, database records, etc.

Display subsystem 1106 may be used to present a visual representation of data held by storage machine 1104, and may display the data on a see-through display, as described above. As the herein described methods and processes change the data held by the storage machine, and thus transform the state of the storage machine, the state of display subsystem 1106 may likewise be transformed to visually represent changes in the underlying data. Display subsystem 1106 may include one or more display devices utilizing virtually any type of technology. Such display devices may be combined with logic machine 1102 and/or storage machine 1104 in a shared enclosure, or such display devices may be peripheral display devices. Display subsystem 1106 also may include an electrochromic, photochromic, and/or tinted structure to help modify a contrast of or other characteristic of a displayed image.

Input subsystem 1108 may comprise or interface with one or more user-input devices such as an image sensor, brightness sensor, microphone, eye tracking system sensor (e.g. inward facing image sensor on a head-mounted display device), global positioning system sensor, motion sensor (e.g. one or more inertial measurement units), touch sensor, button, keyboard, game controller, mouse, optical position tracker, etc. In some embodiments, the input subsystem may comprise or interface with selected natural user input (NUI) componentry. Such componentry may be integrated or peripheral, and the transduction and/or processing of input actions may be handled on- or off-board.

Communication subsystem 1110 may be configured to communicatively couple computing system 1100 with one or more other computing devices (e.g. to communicatively couple a human interface device to a host computing device). Communication subsystem 1110 may include wired and/or wireless communication devices compatible with one or more different communication protocols.

It will be understood that the configurations and/or approaches described herein are presented for the purpose of example, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A see-through head mounted display, comprising:
a see-through display; and
an automatic brightness control system comprising a brightness sensor located behind the see-through display, and also comprising a processor configured to adjust a brightness of a displayed image in correspondence to a measured brightness of a see-through view as measured by the brightness sensor.

2. The see-through head mounted display of claim 1, wherein the see-through head mounted display further comprises a shield lens, and wherein the brightness sensor is positioned near the top of the shield lens and behind the shield lens.

3. The see-through head mounted display of claim 1, wherein the see-through head mounted display further comprises a shield lens, and wherein the brightness sensor is positioned near the side of the shield lens and behind the shield lens.

4. The see-through head mounted display of claim 3, wherein the brightness sensor is positioned in the arm of the head mounted display and behind the shield lens.

5. The see-through head mounted display of claim 3 wherein the brightness sensor is positioned in the frame of the head mounted display and behind the shield lens.

6. The see-through head mounted display of claim 1 wherein the processor is configured to adjust the brightness of the displayed image to maintain a constant ratio between an average perceived brightness of the displayed image and an average perceived brightness of a see-through view.

7. The see-through head mounted display of claim 1 wherein processor is configured to adjust the brightness of the displayed image in further correspondence with a non-linear sensitivity of the human eye.

8. The see-through head mounted display of claim 1, wherein the processor is configured to adjust the brightness of the displayed image by changing code values of the image or by changing illumination of the image source.

9. The see-through head mounted display of claim 8, wherein the processor is configured to change illumination of the image source by changing a voltage, a current or a duty cycle of power to a light source for the image source.

10. The see-through head mounted display of claim 1, further comprising a shield lens, wherein the brightness sensor is located behind the shield lens, and wherein the shield lens comprises a photochromic shield lens, an electrochromic shield lens, or a tinted shield lens.

11. The see-through head mounted display of claim 1 wherein a field of view of the brightness sensor is substantially the same as a field of view of the see-through display.

12. The see-through head mounted display of claim 1, wherein the brightness sensor has multiple pixels for measuring a relative brightness of different portions of a field of view of the see-through display.

13. The see-through head mounted display of claim 1, wherein the processor is configured to display the image as a red or green image based upon the measured brightness being dim.

14. The see-through head mounted display of claim 1, wherein the processor is configured to increase a contrast of the displayed image if a predetermined brightness threshold is exceeded by the measured brightness.

15. A method for controlling a brightness of a displayed image on a see-through head mounted display, the see-through head-mounted display comprising a brightness sensor behind a shield lens, the method comprising:
selecting the brightness of a displayed image relative to a see-through view on the head mounted display;
measuring a brightness of the see-through view using the brightness sensor;
adjusting an brightness of the displayed image automatically in correspondence to measured changes in the brightness of the see-through view; and
providing the displayed image with the adjusted brightness to the head mounted display.

16. The method of claim 15 wherein the adjustment of the brightness of the displayed image further includes adjusting the brightness of the displayed image in correspondence to a human eye sensitivity.

17. The method of claim 15 wherein the adjustment of the brightness of the displayed image includes adjusting one or more of a digital brightness of the displayed image, an illumination in the display optics, and an optical efficiency in the display optics, and an electrochromic layer in the display optics.

18. The method of claim 1 wherein the brightness sensor has multiple pixels to measure the brightness of portions of the see-through field of view and adjust portions of the displayed image.

19. A see-through head mounted display, comprising:
a see-through display;
a shield lens; and
an automatic brightness control system comprising a brightness sensor located behind the shield lens, and also comprising a processor configured to adjust a brightness of a displayed image in correspondence to a measured brightness as measured by the brightness sensor in correspondence with a non-linear sensitivity of the human eye.

20. The see-through head mounted display of claim 19, wherein the processor is configured to adjust the brightness of the displayed image to maintain a constant ratio between an average perceived brightness of the displayed image and an average perceived brightness of a see-through view.
